(19) United States
(12) Patent Application Publication
(10) Pub. No.: US 2008/0056298 A1
(43) Pub. Date: Mar. 6, 2008

(54) Communication system

(75) Inventor: Satoshi Nakayama, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: NEC Corporation, Tokyo (JP)

(21) Appl. No.: 11/895,903

(22) Filed: Aug. 28, 2007

(30) Foreign Application Priority Data
Sep. 1, 2006 (JP) 238290/2006

(51) Int. Cl. H04L 12/413

(52) U.S. Cl. 370/448

(57) ABSTRACT

In a communication system, it is possible to recognize an apparatus to which a transmission inhibited period is set. The communication system includes at least a first communication apparatus (STA 21) and a second communication apparatus (AP 2). The first communication apparatus notifies the second communication apparatus of setting notifying information (NN) indicating the setting of the transmission inhibited period (NAV). The second communication apparatus controls operation, at reception of NN from the first communication apparatus, to preferentially send data addressed to other than the first communication apparatus.

This application is based upon and claims the benefit of priority from Japanese patent application No. 2006-238290, filed on Sep. 1, 2006, the disclosure of which is incorporated herein in its entirety by reference.

### BACKGROUND OF THE INVENTION

1. Field of the Invention

The present invention pertains to a communication system including at least one communication apparatus, and in particular, to a communication system, a communication apparatus, a communication control method, and a communication control program stored on a computer-readable medium that notify peripheral communication apparatuses of information of setting a transmission inhibited period or a Network Allocation Vector (NAV).

2. Description of the Related Art

Recently, there have been broadly adopted wireless Local Area Network (LAN) systems represented by network systems constructed on the basis of Institute of Electrical and Electronics Engineers (IEEE) Radio Standard 802.11.

In this connection, IEEE Radio Standard 802.11 employs access control of radio channels based on a Distributed Coordination Function (DCF).

For example, a Carrier Sense Multiple Access (CSMA)/Collision Avoidance (CA) communication scheme is adopted to avoid data collision in which after a state of use of an associated radio channel is confirmed, it is determined whether or not data is to be transmitted.

Referring now to FIGS. 1 and 2, description will be given of a communication control method in a radio communication system using the CSMA/CA communication scheme.

As FIG. 1 shows, a radio communication system associated with the present invention includes a plurality of radio access points (AP′) and a plurality of wireless terminals or stations (STA′).

In FIG. 1, it is assumed that stations STA′ 11 and STA′ 12 belong to an access point AP′ 1.

Also, stations STA′ 21 and STA′ 22 belong to an access point AP′ 2.

Furthermore, each one of the stations STA′ 11 and STA′ 21 is in a communication range of the other one thereof. In this state, the stations 11 and 21 are communicable with each other.

Referring next to FIG. 2, description will be given of a communication control method in the wireless communication system shown in FIG. 1.

At occurrence of transmission data to the station 11, the access point 1 senses carriers to check a state of uses of radio channels to determine whether or not a radio channel is available for the transmission (step S′1).

In the carrier sense step, the access point 1 measures levels of power of radio signals received from the peripheral stations, i.e., the stations 11 and 12 in FIG. 1 to determine for each radio signal whether of not the power level is less than a threshold value, i.e., a carrier sense level beforehand set to the access point 1.

If the power level is less than the carrier sense level, the access point 1 determines that the radio channel is available. Otherwise, the access point 1 determines that the radio channel is not available.

If the channel is available, the access point 1 waits for a lapse of a period of time randomly determined, called “back-off time”.

In the creation of the back-off time, a random number is generated in a range of a predetermined Contention Window (CW) to uniquely determine the back-off time according to the random number.

If it is determined that the radio channel is also free after the lapse of the back-off time, the access point 1 delivers a Request To Send (RTS) to the station 11 to reserve the channel (step S′2).

In the operation, the access point 1 also sends the RTS signal to the station 12 existing in the communication range.

The RTS signal includes information such as a channel use period of time, a destination station address (of the station 11), and a source station address (of the access point 1). The channel use period of time indicates a period of time in which the access point 1 uses the radio channel.

When the RTS is received, the station STA′ 12 refers to the destination station address contained in the RTS. If it is determined that the address is other than that of the station 12, the station 12 refers to the channel use period of time in the RTS to set a Network Allocation Vector (NAV).

As a result, the station 12 sets as a transmission inhibited period the period of time in which the access point 1 uses the radio channel.

Also, at reception of the RTS from the access point 1, the station 11 refers to the destination station address in the RTS. If it is determined that the address is that of the station 11, the station 11 sends a Clear To Send (CTS) to the access point 1 to reserve a channel (step S′3).

In this situation, the station 11 transmits the CTS also to the station 21 present in the communication range.

The CTS signal includes information items such as a channel use period of time and a destination station address (of the access point 1). The channel use period of time represents a period of time in which the station 11 uses the radio channel.

When the CTS is received from the station 11, the station 21 refers to the destination address in the CTS signal. If the address is other than that of the station 21, the station 21 refers to the channel use period of time included in the CTS to resultantly set an NAV.

Therefore, the period of time in which the station 11 uses the radio channel is set as a transmission inhibition period.

Also, at reception of the CTS signal, the access point 1 refers to the destination address in the CTS. If the address is that of the access point 1, the access point 1 delivers transmission data to the station 11 (step S′4).

On receiving the data from the access point 1, if it is determined that the data reception is completed, the station 11 sends Acknowledgement (ACK) to the access point 1 (step S′13).

As above, according to the communication control method employing the CSMA/CA scheme, the RTS and CTS signals are transmitted respectively in steps S′2 and S′3 between the radio communication apparatuses to possibly avoid data collision to thereby improve communication efficiency.

However, in the communication control method, when a channel reserve signal such as the RTS signal is received, the station 21 having set the NAV cannot transmit a response signal such as the CTS signal.

As a result, even if the access point 2 sends a channel reserve signal, e.g., the RTS signal to the station 21, it is not possible for the access point 2 to receive a response signal to the channel reserve signal from the station 21. Resultantly, the access point 2 again delivers a channel reserve signal to the station 21.

That is, the access point 2 disadvantageously carries out an unnecessary operation to retransmit the channel reserve signal, which deteriorates the communication efficiency.

Referring next to FIG. 2, description will be given in detail of the situation in which such unnecessary retransmission is conducted.

Assume now that data to be sent to the station 21 and data to be delivered to the station 22 sequentially appear in the access point 2.

In this event, the access point 2 senses carriers (step S′5) and then transmits an RTS signal to the station 21 (step S′6).

Although the station 21 is capable of normally receive the RST signal, the station 21 has set the NAV and hence cannot send a CTS signal to the access point 2.

Therefore, the access point 2 cannot receive the CTS within a fixed period of time from the station 21, and the access point 2 repeatedly delivers the RTS signal to the station 21 (steps S′7 and S′8).

As above, in the communication control method, the station 21 cannot send the CTS signal to the access point 2 so long as the SAV is kept set.

During the period of time in which the CTS signal cannot be received from the station 21, the access point 2 attempts the retransmission of the RTS signal to the station 21 (steps S′7 to S′12).

That is, during the period of time in which the access point 2 is trying to retransmit RTS to the station 21, the access point 2 cannot send transmission data to the station 22, resultantly lowering the communication efficiency.

Therefore, it is highly required to devise a communication control method which suppresses the data retransmission to the communication apparatus (the station 21) having set the NAV to thereby prevent the deterioration of the communication efficiency.

In this connection, for example, Japanese Patent Application Laid-Open No. 2001-345809 describes a technique of a radio packet transmission method filed prior to the present invention. According to the technique, by improving the MAC protocol of IEEE 802.11 Standard, the efficiency of data packet communication is improved.

Also, for example, according to Japanese Patent Application Laid-Open No. 2004-364121, there is disclosed a technique in which a communication apparatus having received an RTS signal or a CTS signal starts transmission of data after a short period of wait time to thereby improve the data transmission efficiency.

Additionally, for example, Japanese Patent Application Laid-Open No. 2006-20290 describes a technique of avoiding the collision of transmission data from a first radio communication apparatus against transmission data from a second radio communication apparatus.

However, the techniques described above have not given consideration to an idea of operation in which a communication apparatus notifies peripheral communication apparatuses of an event of the setting a transmission inhibited period so that the peripheral communication apparatuses recognize the apparatus having set the transmission inhibited period.

### SUMMARY OF THE INVENTION

An exemplary objection of the invention is to provide a communication system, a communication apparatus, a communication control method, and a communication control program stored on a computer-readable medium to recognize an apparatus to which a transmission inhibited period is set.

A communication system according to an exemplary aspect of the invention includes a first communication apparatus and a second communication apparatus. The first communication apparatus includes a collision avoiding control unit that sets a transmission inhibited period and controlling operation to avoid data collision during the transmission inhibited period and a notifying unit that notifies the second communication apparatus of setting notifying information indicating the setting of the transmission inhibited period. The second communication apparatus includes a transmission control unit that controls, at reception of the setting notifying information from the first communication apparatus, operation to preferentially transmit data addressed to other than the first communication apparatus.

A communication system according to an exemplary aspect of the invention includes a first communication apparatus and a second communication apparatus. The first communication apparatus includes a collision avoiding control unit that sets a transmission inhibited period and controlling operation to avoid data collision during the transmission inhibited period and a notifying unit that notifies the second communication apparatus of setting notifying information indicating the setting of the transmission inhibited period. The second communication apparatus includes a transmission control unit that controls, at reception of the setting notifying information from the first communication apparatus, operation to preferentially transmit data addressed to other than the first communication apparatus.

A communication apparatus according to an exemplary aspect of the invention sets a transmission inhibited period and controlling operation to avoid data collision during the transmission inhibited period. The communication apparatus includes a notifying unit that notifies peripheral communication apparatuses existing in a periphery of the communication apparatus of setting notifying information indicating the setting of the transmission inhibited period.

A communication apparatus according to an exemplary aspect of the invention sets a transmission inhibited period and controlling operation to avoid data collision during the transmission inhibited period. The communication apparatus includes a notifying unit that notifies peripheral communication apparatuses existing in a periphery of the communication apparatus of setting notifying information indicating the setting of the transmission inhibited period.

A communication apparatus according to an exemplary aspect of the invention transmits data to peripheral communication apparatuses existing in a periphery of the communication apparatus. The communication apparatus includes a transmission control unit that preferentially transmits, at reception of setting notifying information indicating setting of a transmission inhibited period to avoid data collision from one of the peripheral communication apparatuses, data addressed to other than the peripheral communication apparatus from which the setting notifying information is received.

A communication apparatus according to an exemplary aspect of the invention transmits data to peripheral communication apparatuses existing in a periphery of the communication apparatus. The communication apparatus includes a transmission control unit that preferentially transmits, at reception of setting notifying information indicating setting of a transmission inhibited period to avoid data collision from one of the peripheral communication apparatuses, data addressed to other than the peripheral communication apparatus from which the setting notifying information is received.

A communication control method according to an exemplary aspect of the invention is applied to a communication system including at least a first communication apparatus and a second communication apparatus. The first communication apparatus conducts a collision avoiding control process for setting a transmission inhibited period and controlling operation to avoid data collision during the transmission inhibited period and a notifying process for notifying the second communication apparatus of setting notifying information indicating the setting of the transmission inhibited period. The second communication apparatus conducts a transmission control process for controlling, at reception of the setting notifying information from the first communication apparatus, operation to preferentially transmit data addressed to other than the first communication apparatus.

A communication control method according to an exemplary aspect of the invention is applied to a communication apparatus for setting a transmission inhibited period and controlling operation to avoid data collision during the transmission inhibited period. The communication apparatus conducts a notifying process for notifying peripheral communication apparatuses existing in a periphery of the communication apparatus of setting notifying information indicating the setting of the transmission inhibited period.

A communication control method according to an exemplary aspect of the invention is applied to a communication apparatus for transmitting data to peripheral communication apparatuses existing in a periphery of the communication apparatus. The communication apparatus conducts a transmission control process for preferentially transmitting, at reception of setting notifying information indicating setting of a transmission inhibited period to avoid data collision from one of the peripheral communication apparatuses, data addressed to other than the peripheral communication apparatus from which the setting notifying information is received.

A communication control program stored on a computer-readable medium according to an exemplary aspect of the invention is executed for a communication apparatus for setting a transmission inhibited period and controlling operation to avoid data collision during the transmission inhibited period. The program causes a computer to perform notifying processing for notifying peripheral communication apparatuses existing in a periphery of the communication apparatus of setting notifying information indicating the setting of the transmission inhibited period.

A communication control program stored on a computer-readable medium according to an exemplary aspect of the invention is executed for a communication apparatus for transmitting data to peripheral communication apparatuses existing in a periphery of the communication apparatus. The program causes a computer to perform transmission control processing to preferentially transmit, at reception of setting notifying information indicating setting of a transmission inhibited period to avoid data collision from one of the peripheral communication apparatuses, data addressed to other than the peripheral communication apparatus from which the setting notifying information is received.

### BRIEF DESCRIPTION OF THE DRAWINGS

Features of the disclosed embodiments will be described by way of the following detailed description with reference to the accompanying drawings in which:

FIG. 1 is a block diagram showing a system configuration of a radio communication system associated with the present invention;

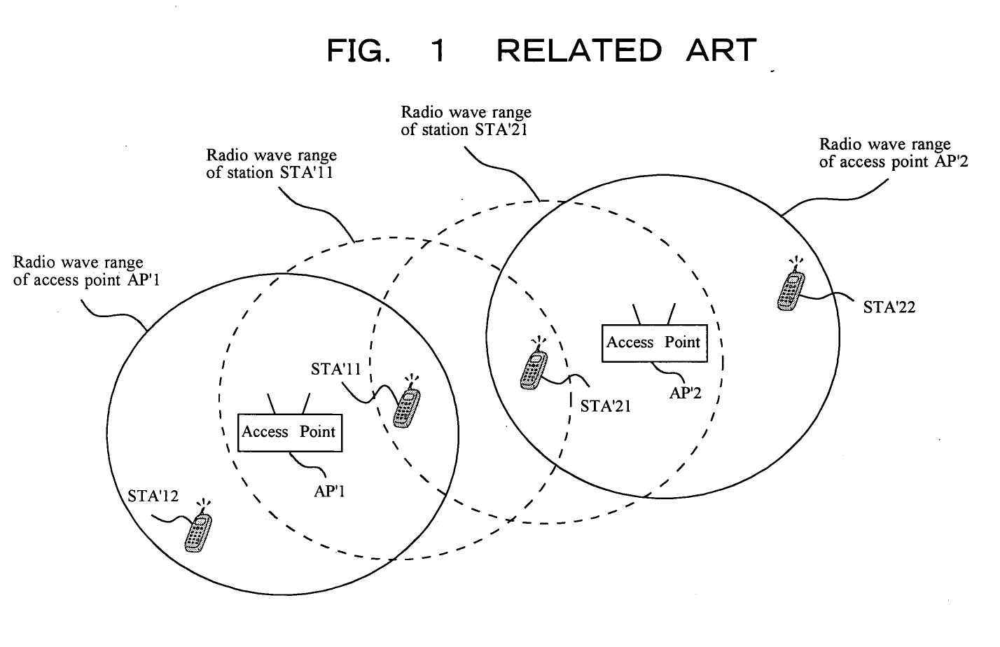

FIG. 2 is a sequence chart showing a sequence of processing steps in the wireless communication system associated of FIG. 1;

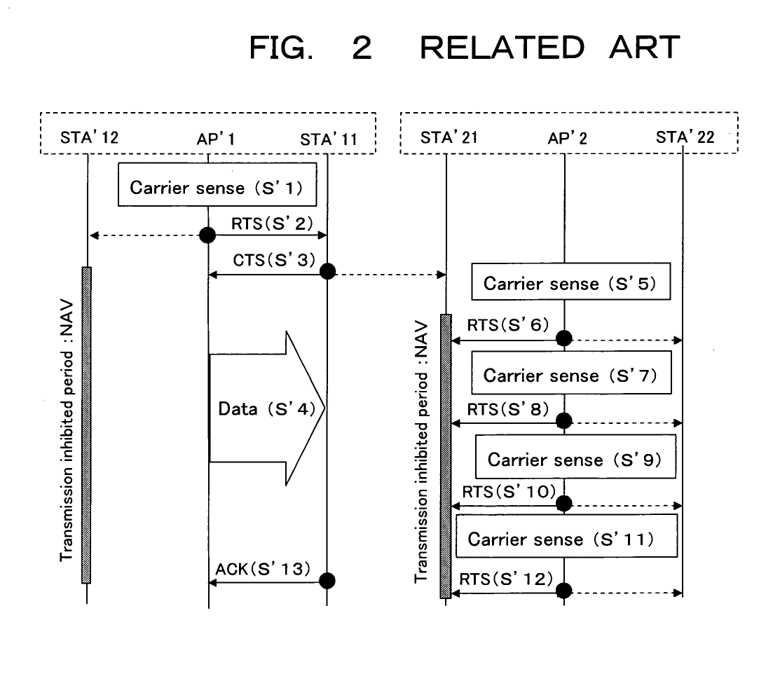

FIG. 3 is a block diagram showing a system configuration of a communication system in accordance with the present invention;

FIG. 4 is a diagram showing an internal configuration of a communication apparatus (an access point, a station) of a communication system;

FIG. 5 is a flowchart showing processing steps to be executed at occurrence of transmission data;

FIG. 6 is a flowchart showing data transmission start processing;

FIG. 7 is a flowchart showing processing steps to be executed at reception of an RTS signal;

FIG. 8 is a flowchart showing processing steps to be executed when a CTS signal is received;

FIG. 9 is a flowchart showing processing steps to be executed at reception of data;

FIG. 10 is a flowchart showing processing steps to be executed when an ACK signal is received;

FIG. 11 is a flowchart showing data transmission end processing;

FIG. 12 is a flowchart showing processing steps to be executed when a period of time set to a timer lapses;

FIG. 13 is a flowchart showing processing steps to be executed after an NN signal is received;

FIG. 14 is a first flowchart showing a sequence of processing steps of a communication system;

FIG. 15 is a table showing a transmission order of data items in a transmission queue existing in an access point (AP2);

FIG. 16 is a table showing a transmission order of data items after the transmission order shown in FIG. 15 is arbitrarily changed;

FIG. 17 is a table showing a transmission order of data items after the transmission order of FIG. 16 is changed;

FIG. 18 is a second flowchart showing a sequence of processing steps of a communication system;

FIG. 19 is a second table showing a transmission order of data items after the transmission order of FIG. 15 is altered;

FIG. 20 is a sequence chart showing a sequence of processing steps in a communication system of a second embodiment;

FIG. 21 is a table showing a transmission order of data items in a transmission queue existing in the access point (AP 2); and

FIG. 22 is a first table showing a transmission order of data items after the transmission order of FIG. 25 is varied.

### DESCRIPTION OF EXEMPLARY EMBODIMENTS

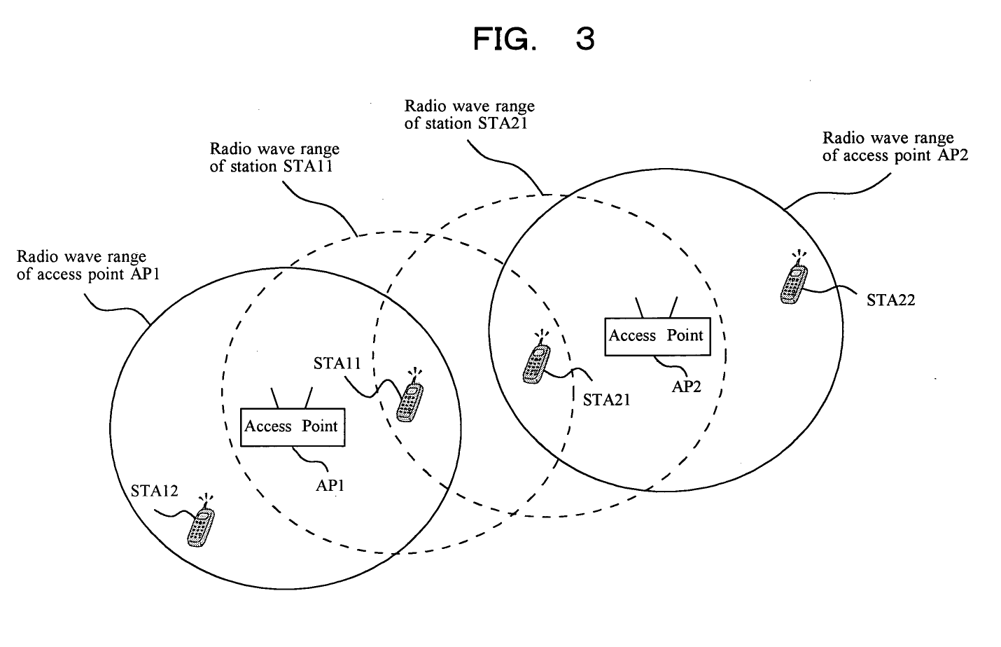

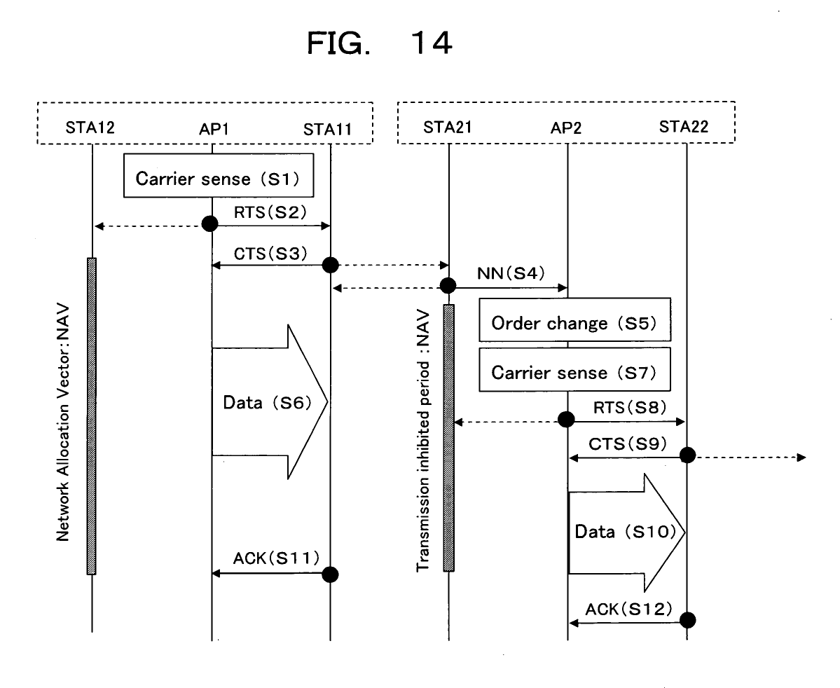

Referring next to FIGS. 3 and 14, description will be given of an outline of a communication system.

As FIG. 3 shows, a communication system at least includes a first communication apparatus (corresponding to the radio station STA 21) and a second communication apparatus (corresponding to the access point AP 2).

As can be seen from FIG. 14, the station STA 21 sends to the access point AP 2 setting notifying information (NN) notifying the setting of a transmission inhibited period (NAV; step S4).

At reception of the information (NN) from the station STA 21, the access point AP 2 controls operation such that any transmission data addressed to other than the station STA 21 takes precedence over that addressed to the station STA 21 (step S5).

The station STA 21 delivers the setting notification of the setting of NAV to the access point AP 2. It is hence possible for the access point AP 2 to recognize that NAV is set to the station STA 21.

At reception of the setting notification (NN), the access point AP 2 controls operation such that the transmission data addressed to other than the station STA 21 takes precedence in the transmission.

As a result, even if there exists transmission data addressed to the station STA 21 to which NAV is set, the access point AP 2 is capable of preferentially transmitting the transmission data to another communication apparatus (STA 22) to which NAV is not set.

Therefore, the access point AP 2 suppresses the data transmission to the station STA 21 to which NAV is set to thereby avoid the deterioration of the communication efficiency.

Referring next to the accompanying drawings, description will be given in detail of the embodiment of the communication system.

### First Exemplary Embodiment

### <System Configuration of Communication System>

Referring to FIG. 3, description will be given of a system configuration of the communication system.

As FIG. 3 shows, the communication system includes a plurality of radio base stations or access points (AP) and a plurality of radio terminals or stations (STA).

Each of the access points AP 1 and AP 2 is not within a communication range of the other one thereof as shown in FIG. 3, and hence it is not possible for each access point (AP 1, AP 2) to recognize existence of an adjacent access point.

It is assumed in FIG. 3 that the stations STA 11 and STA 12 belong to the access point AP 1.

Also, the stations STA 21 and STA 22 belong to the access point AP 2.

Moreover, the stations STA 11 and STA 21 are mutually in the communication range of the other one thereof, and hence these stations are capable of conducting radio communication with each other.

The communication system of the embodiment is not limited to the system configuration shown in FIG. 3, but the numbers respectively of stations and access points are not particularly restricted, and hence the system may include desired numbers respectively of stations and access points.

### <Internal Structure of Access Point and Station>

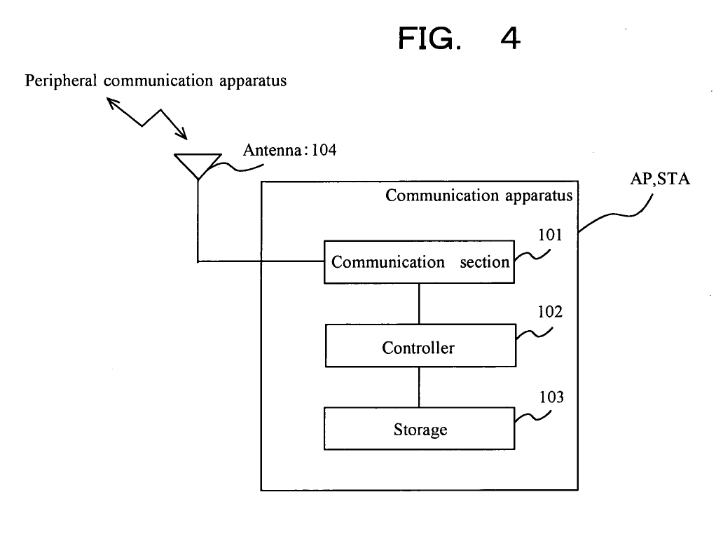

Next, referring to FIG. 4, description will be given of internal structure of the access point and the station included in the communication system.

In this regard, each of the access point and the station of the communication system may be configured using almost one and the same function, and hence each thereof will be referred to as a communication apparatus hereinbelow.

As FIG. 4 shows, the communication apparatus of the embodiment includes a communication module 101, a controller 102, a storage 103, an antenna 104.

The communication module 101 establishes a radio communication line via the antenna 104 to a second communication apparatus to communicate information with the second communication apparatus using a desired frequency.

The communication module 101 converts transmission data addressed to the destination into a radio signal to transmit the signal via the antenna 104 to the destination.

Also, the communication module 101 decodes the radio signal received via the antenna 104 to create received data.

The controller 102 controls operation conducted in the communication apparatus.

The storage 103 stores various setting values in the communication apparatus and temporarily stores information communicated via the communication module 101.

The setting values include a carrier sense level as a determination criterion to determine presence or absence of a communication apparatus in communication and a radio channel, and a service identifier or a Service Set Identifier (SSID).

### Processing at Occurrence of Transmission Data

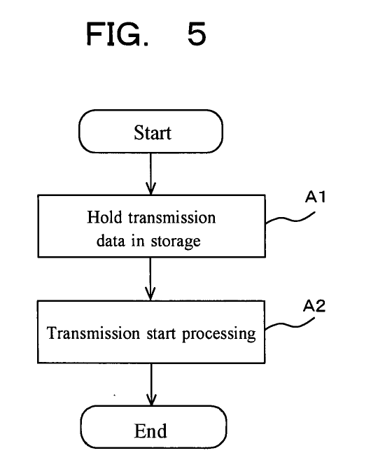

Referring now to FIG. 5, description will be given of processing to be performed at occurrence of transmission data.

The controller 102 temporarily holds the transmission data in the storage 103 (step A1).

It is hence possible that the controller 102 executes data retransmission processing by use of the transmission data provisionally held in the storage 103.

Next, the controller 102 delivers through the data retransmission processing the transmission data to a second communication apparatus (step A2) and then terminates the processing.

### Transmission Start Processing

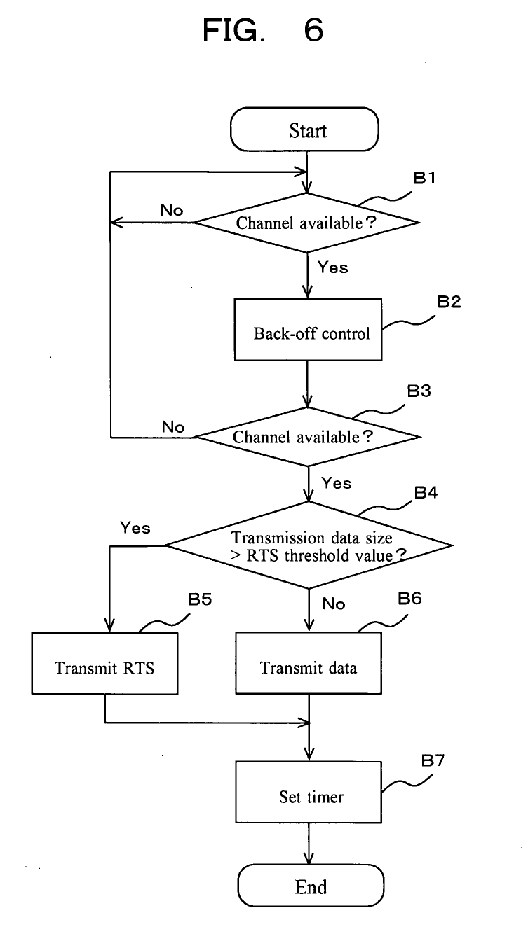

Referring now to FIG. 6, description will be given of operation of the transmission start processing.

The controller 102 senses carriers to determine presence or absence of an available radio channel (step B1).

In the carrier sense operation, the controller 102 makes a check to determine whether or not the power level of the radio signal received from the associated communication apparatus is less than a threshold value, i.e., a carrier sense level beforehand stored in the storage 103. If the power level is equal to or more than the threshold value, the controller 102 determines that there exists no available channel. Otherwise, the controller 102 determines that there exists an available channel.

If it is determined that there exists no available channel (no in step B1), the controller 102 again senses carriers to determine presence or absence of an available radio channel (step B1).

If it is determined that there exists an available channel (yes in step B1), the controller 102 waits for the lapse of a random period of time called back-off time (step B2).

Thanks to the wait time, the controller 102 is capable of suppressing the occurrence of data collision due to simultaneous data transmission from another communication apparatus.

The back-off time is uniquely determined using a random number created within a predetermined Contention Window (CW).

The controller 102 conducts a carrier sense operation to determine presence or absence of an available radio channel (step B3). If it is determined that no available channel is present (no in step B3), the process goes again to step B1 in which the controller 102 conducts a carrier sense operation to determine presence or absence of an available radio channel (step B1).

If it is determined that an available channel is present (yes in step B3), the controller 102 makes a check to determine whether or not the data size of the transmission size exceeds the RTS threshold value (step B4).

The RTS threshold value is a value of a determination criterion to determine whether or not the RTS/CTS change control is conducted in the transmission of the data.

If the transmission data size exceeds the RTS threshold value (yes in step B4), the controller 102 sends an RTS signal (step B5).

The controller 102 resultantly delivers the transmission data, which exceeds the threshold value, after the RTS/CTS change control. It is hence possible to avoid data collision to safely send the data.

If the data size of the transmission data is equal to or less than the RTS threshold value (no in step B4), the controller 102 sends the transmission data (step B6).

As a result, the controller 102 transmits the data not exceeding the RTS threshold value without conducting the RTS/CTS change control, and hence the data transmission is efficiently carried out.

The controller 102 accomplishes a timer setting operation (step B7) and then terminates the processing.

The timer setting operation in step B7 is conducted to determine whether or not the transmission data is to be retransmitted.

### Processing at Reception of RTS

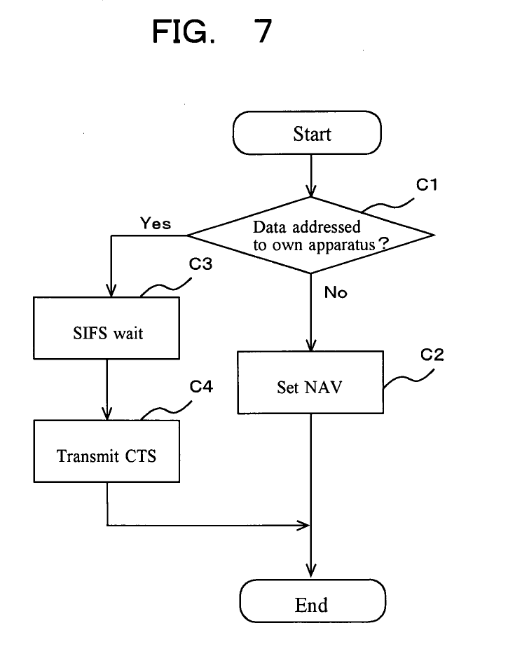

Referring next to FIG. 7, description will be given of processing when the RTS signal is received.

At reception of RTS, the controller 102 makes a check to determine, on the basis of destination terminal address information included in RTS, whether or not the information indicates the controller 101 itself (step C1).

If the address information indicates the controller 102 (yes in step C1), the controller 102 waits for the lapse of a period of time determined by a Short Inter Frame Space (SIFS; step C3).

The controller 102 then transmits a CTS signal (step C4).

If the address information indicates other than the controller 102 itself (no in step C1), the controller 102 sets a transmission inhibited period “NAV” using channel use time information contained in RTS (step C2).

The controller 102 accordingly controls operation to prevent data transmission until the period of NAV is expired.

The period of NAV may be set, for example, in a method in which a transmission inhibited period is calculated using the data size and the transmission speed or bit rate of the transmission data to set the calculated period to NAV.

### Processing at Reception of CTS

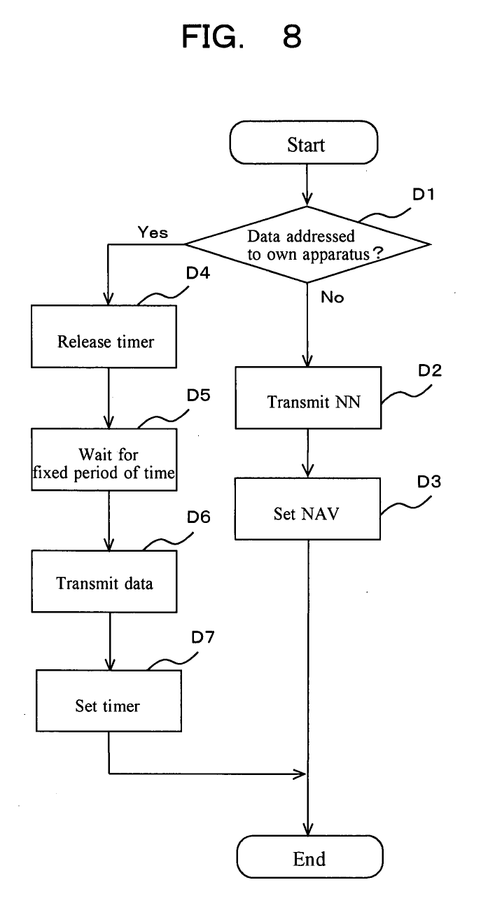

Referring now to FIG. 8, description will be given of processing to be executed when CTS is received.

At reception of a CTS signal, the controller 102 makes a check to determine whether or not CTS is address to the controller 102 itself (step D1).

If the destination terminal address information in CTS indicates other than the controller 102 itself (no in step D1), the controller 102 delivers, to peripheral communication apparatuses, “NAV Notification (NN)” indicating that the transmission inhibited time “NAV” is set (step D2).

It is hence possible that the controller 102 notifies the peripheral communication apparatuses of the information that NAV is set.

In this connection, NN includes transmission source terminal address information of the NN transmission source terminal and setting period information of NAV.

Based on the channel use time information in CTS, the controller 102 sets NAV (step D3) and terminates the processing.

If CTS is addressed to the controller 102 itself (yes in step D1), the controller 102 releases the timer set in step B7 of FIG. 6 (step D4).

It is therefore possible for the controller 102 to release, after sending RTS in step B5 of FIG. 6, the timer set in step B7.

The controller 102 waits for the lapse of the fixed period of time based on the channel use time information in CTS (step D5) and then starts data transmission (step D6). The controller 102 sets a period of time to the timer (step D7) to thereby terminate the processing.

### Processing at Reception of Data

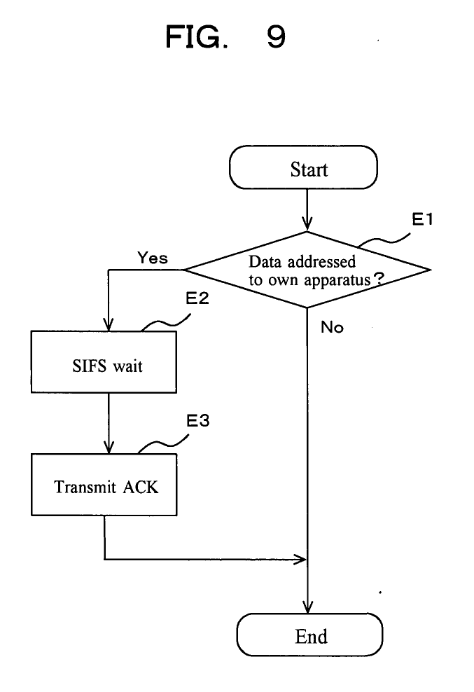

Referring now to FIG. 9, description will be given of processing to be performed when the data is received.

At reception of the data, the controller 102 makes a check, according to the destination address information contained in the data, to determine whether of not the address information indicates the controller 102 itself (step E1).

If it is determined that the address information indicates the controller 102 (yes in step E1), the controller 102 waits for the lapse of a period of time determined by SIFS (step E2) and then transmits ACK (step E3).

If the address information indicates other than the controller 102 (no in step E1), the controller 102 terminates the processing without conducting any particular operation.

### Processing at Reception of ACK

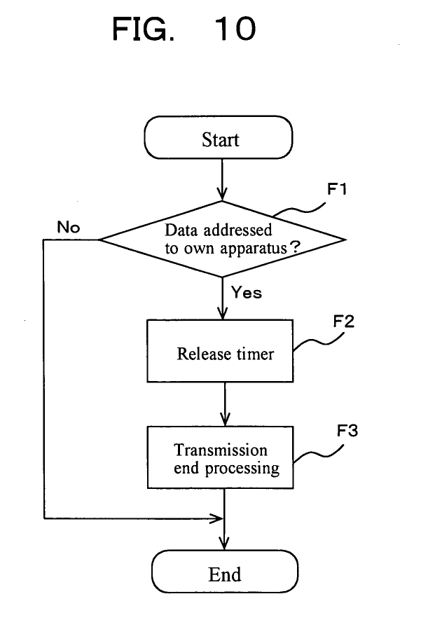

Next, description will be given of processing to be performed at reception of ACK by referring to FIG. 10.

When ACK is received, the controller checks the destination address information contained in ACK and determines whether of not the address information indicates the controller 102 itself according to the address information (step F1).

If address information indicates the controller 102 (yes in step F1), the controller releases the setting to the timer (step F2).

Resultantly, the controller releases, after transmitting the transmission data in step B6 of FIG. 6, the timer set in step B7 or in step D7 shown in FIG. 8.

The control module 102 then executes the transmission end processing (step F3).

If address information does not indicate the control module 102 (no in step F1), the control module 102 does not execute any particular processing, but terminates the processing.

### Transmission End Processing

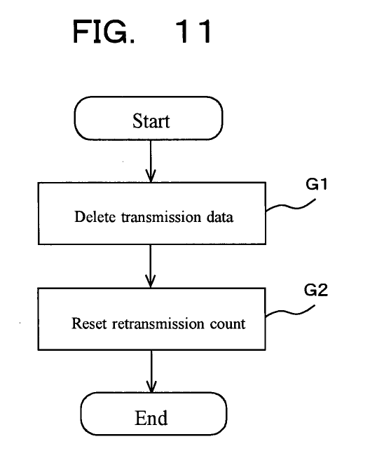

Referring now to FIG. 11, description will be given of the transmission end processing.

The controller 102 first deletes the transmission data temporarily held in the storage 103 (step G1).

Thereafter, the controller 102 resets the retransmission count of the transmission data deleted in step G1 (step G2).

The retransmission count indicates the number of retries made to transmit the transmission data.

### Processing at Expiration of Timer

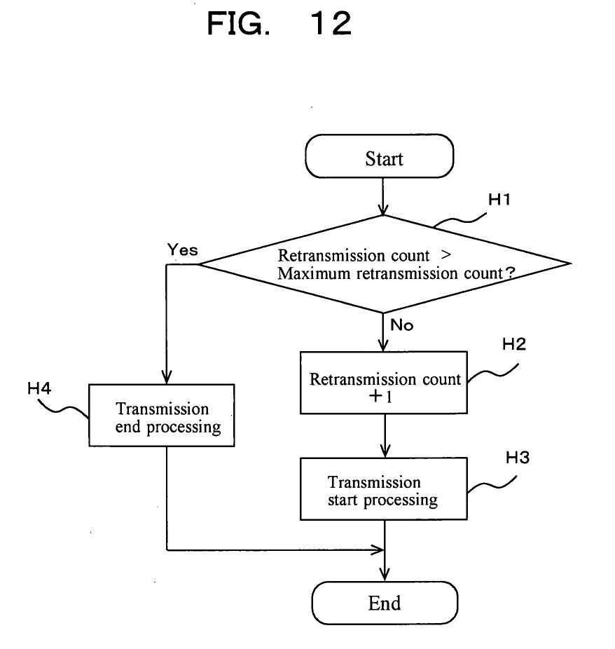

Referring to FIG. 12, description will be given of processing to be performed when the timer setting is expired.

This processing is executed when a predetermined period of time set to the timer in step B7 is expired after the data transmission in step B6 of FIG. 6 or in step D7.

The controller 102 refers to the storage 103 and determines whether or not the retransmission count of the transmission data exceeds the maximum retransmission count stored in the storage 103 (step H1).

If it is determined that the retransmission count exceeds the maximum retransmission count (yes in step H1), the controller 102 performs the transmission end processing (step H4).

If the retransmission count does not exceed the maximum retransmission count (no in step H1), the controller 102 adds one to the retransmission count (step H2) and executes the transmission start processing shown in FIG. 6 to thereby transmit the data (step H3).

### Processing after Reception of NN

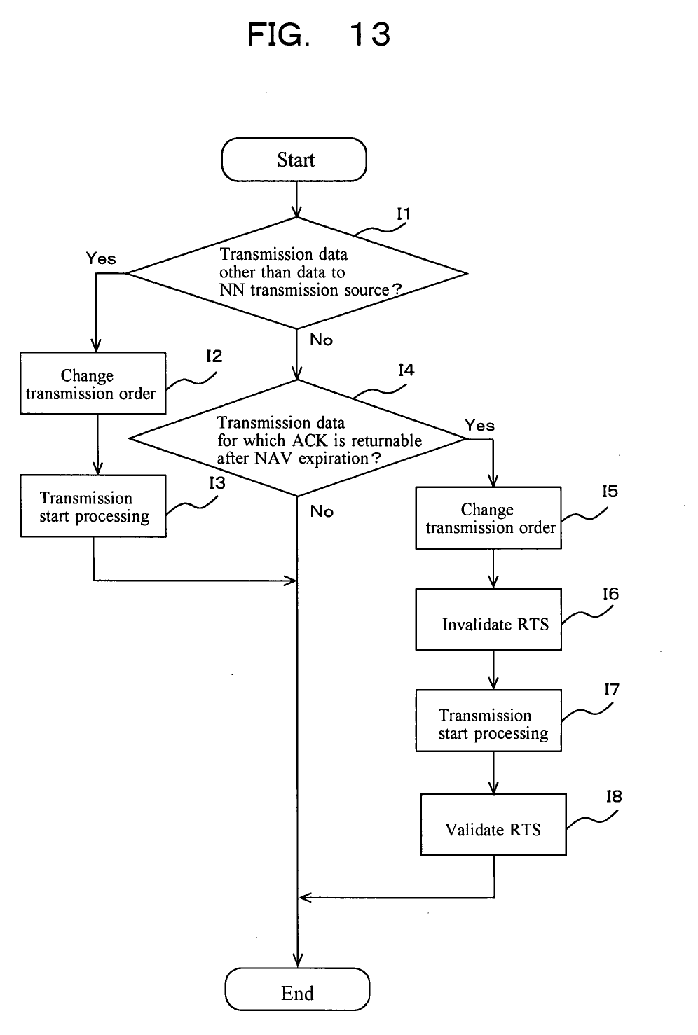

Referring now to FIG. 13, description will be given of processing to be executed after NN is received.

At reception of NN, the controller 102 checks the destination address information contained in NN and then determines, based on the address information, presence or absence of transmission data address to other than the communication apparatus associated with the address information (step 11).

It is therefore possible for the controller 102 to determine presence or absence of data to be delivered to other than the NN source communication apparatus.

If transmission data to other than the NN source is present (yes in step I1), the controller 102 changes the transmission order of the transmission data so that the transmission data to other than the NN source takes precedence in the transmission over the transmission data to the NN source (step I2).

As a result, even there exists transmission data address to the NN transmission source to which the transmission inhibited period “NAV” is set, the controller 102 preferentially delivers the transmission data to other than the NN source.

It is now possible that the controller 102 suppresses retransmission of the data to the NN source apparatus to which NAV is set and hence avoids the lowering of the communication efficiency.

The controller 102 then executes the transmission start processing of FIG. 6 to send the transmission data (step I3).

Also, if there exists no transmission data to the NN source apparatus (no in step I1), the control unit 102 checks, after the NAV period of the NN source is expired, the setting period information in NN to thereby determine presence or absence of transmission data which is addressed to the NN source and to which ACK is returnable (step I4).

If it is determined that there exists such transmission data (yes in step I4), the control unit 102 varies the transmission order to preferentially deliver the transmission data addressed to the NN source (step I5).

It is resultantly possible that even if transmission data address to the NN source apparatus is received, the controller 102 receives ACK therefrom and hence avoids the retransmission of the transmission data address to the NN source.

Next, the controller 102 invalidates the RTS/CTS change control (step I6) and conducts the transmission start processing shown in FIG. 6 to deliver the data (step I7).

This enables the controller 102, in the transmission of data address to the NN source, to deliver the transmission data addressed to the NN source without carrying out the TS/CTS change control, to thereby avoid the unnecessary retransmission of the data.

Incidentally, the control method to invalidate the TS/CTS change control is not particularly restricted, but may be invalidated in any control method only if the control operation is carried out so that the transmission data addressed to the NN transmission source is delivered without conducting the RTS/CTS change control.

For example, there may be used a method in which the RTS threshold value as the determination criterion to decide whether or not the RTS/CTS change control is accomplished is changed to a value more than the data size of the transmission data sent to the NN transmission source.

The method to change the RTS threshold value is not particularly limited, but it is possible to designate any RTS threshold value only if the RTS/CTS change control is not conducted as above.

The controller 102 then releases the invalidation of the RTS/CTS change control, i.e., validates the control (step 18) and then terminates the processing.

### Sequence of Processing Steps in the Communication System

Referring to Figs. 3 and 14, description will be given of a sequence of processing steps in the communication system.

It is assumed in the processing shown in FIG. 14 that transmission data addressed to the station STA 11 occurs in the access point AP 1.

Also, transmission data to the station STA 21 and transmission data to the station STA 22 sequentially occur in the access point AP 2.

As FIG. 14 shows, the access point AP 1 senses carriers to check the state of use of radio channels to determine presence or absence of an available channel (step S1).

If it is determined that there exists an available radio channel, the station AP 1 waits for the lapse of a back-off period of time.

If the available channel still exists after the lapse of the back-off time, the access point AP 1 sends “Request To Send (RTS)” to the station STA 11 to reserve the channel (step S2).

In the operation, the access point AP 1 sends RTS also to the station STA 12 existing in the communication range of the access point AP 1.

The RTS signal includes channel use time information, destination address information (address information of STA 11), and source address information (address information of AP 1). The channel use time information indicates a period of time in which the access point AP 1 occupies the associated channel.

When RTS is received from the access point AP 1, the station STA 12 refers to the destination address information in RTS. If it is determined that the address information indicates other than the station STA 12, the station STA 12 refers to the channel use time information in RTS received from the access point AP 1 to resultantly set a transmission inhibited period, i.e., a Network Allocation Vector (NAV).

The station STA 12 is hence capable of setting as the transmission inhibited period the period of time in which the access point AP 1 uses the channel.

On the other hand, when RTS is received from the access point AP 1, the station STA 11 transmits, if it is determined that the address information indicates the station STA 11, “Clear To Send (CTS)” to the access point AP 1 to reserve the channel (step S3).

In the operation, CTS is sent also to the station STA 21 existing in the communication range of the station STA 11.

The CTS signal includes channel use time information and destination address information (address information of AP 1). The channel use time information indicates a period of time in which the station STA 11 uses the associated channel.

At reception of CTS from STA 11, the station STA 21 checks the destination address information in CTS. If the address information indicates other than the station STA 21, the station STA 21 delivers NN indicating the setting of a transmission inhibited period (NAV), to peripheral communication apparatuses (AP 2, STA 11) in the communication range of the station STA 21 (step S4).

In the transmission of NN to the peripheral communication apparatuses (AP 2, STA 11), there likely occurs a situation in which a plurality of communication apparatuses simultaneously transmit NN. It is hence desirable in the transmission of NN that the station STA 21 conducts, for example, the back-off control to avoid the signal collision.

Therefore, the station STA 21 is capable of notifying NN to the neighborhood communication apparatuses (AP 2, STA 11) while avoiding the data collision with such peripheral apparatuses.

The NN signal includes source address information of the source of NN (address information of STA 21) and NAV setting period information.

The station STA 21 refers to the channel use time information in CTS from STA 11 to thereby set a transmission inhibited period (NAV).

Through the operation, the station STA 21 sets as the transmission inhibited period the period of time in which STA 11 occupies the radio channel.

At reception of NN from STA 21, the access point AP 2 varies the data transmission order based on the source address information (address information of STA 21) in NN so that the transmission data addressed to other than STA 21, i.e., addressed to STA 22 takes precedence over that addressed to STA 21 (step S5).

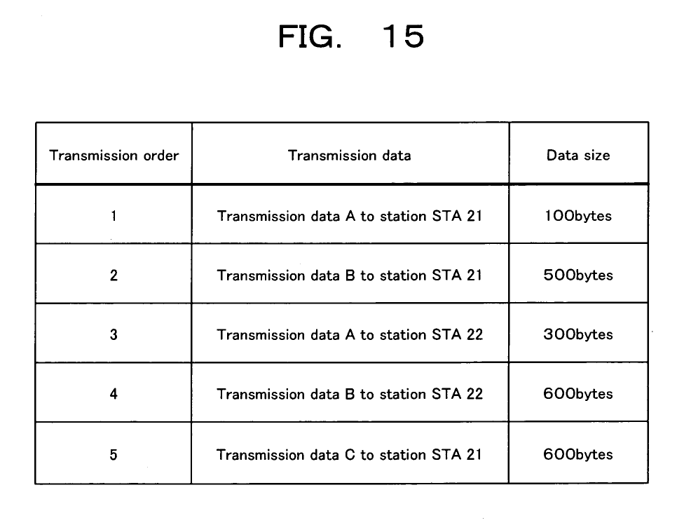

Assume, for example, that the access point AP 2 manages the data items in the transmission queue in the transmission order as shown in FIG. 15.

FIG. 15 shows that the transmission order of data items is managed in a sequence of “data A to STA 21”, “data B to STA 21”, “data A to STA 22”, “data B to STA 22”, and “data C to STA 21”.

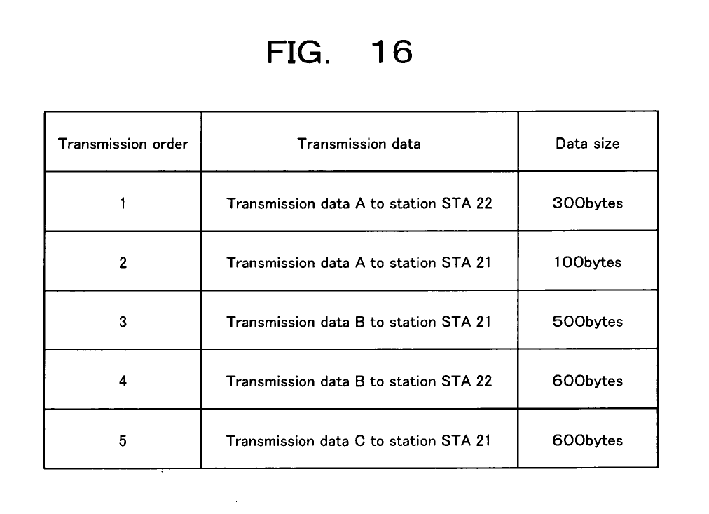

In this state, if NN is received from STA 21, the access point AP 2 alters the transmission order of the data items in the queue based on the source address information (address information of STA 21) in NN as shown in FIG. 16 so that the transmission data addressed to other than STA 21, i.e., that addressed to STA 22 is preferentially delivered at least one position earlier in the transmission order.

FIG. 16 shows a state in which the transmission order of data items is managed in a sequence of “data A to STA 22”, “data A to STA 21”, “data B to STA 21”, “data B to STA 22”, and “data C to STA 21”.

That is, FIG. 16 shows the transmission sequence change result to preferentially deliver the transmission data A addressed to the station STA 22.

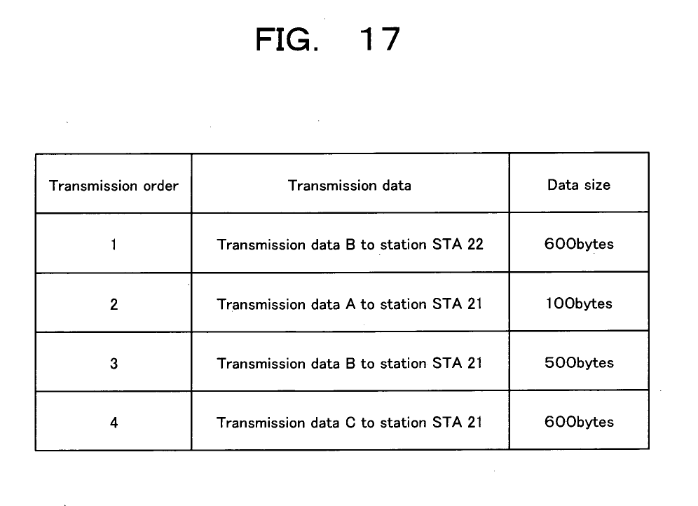

After transmitting the first data in FIG. 16, i.e., “data A to STA 22”, if it is determined according to the NAV setting period information in NN that the transmission inhibited period (NAV) is not expired, the access point AC 2 changes the transmission sequence as shown in FIG. 17 so that the data address to other than STA 21 is preferentially sent at least one position earlier in the transmission order. Specifically, the first data in FIG. 17, i.e., “data B to STA 22” is transmitted.

According to FIG. 17, the transmission order of data items is managed in a sequence of “data B to STA 22”, “data A to STA 21”, “data B to STA 21”, and “data C to STA 21”.

That is, in the state of the transmission sequence shown in FIG. 17, data B addressed to the station STA 22 takes precedence in the transmission.

After the first data, i.e., data A to STA 22 in FIG. 16 is delivered, it is determined on the basis of the NAV setting period in NN that the transmission inhibited period (NAV) is expired, the access point AP 2 sends the second data, i.e., “data A to STA 21” shown in FIG. 16.

As above, at reception of NN from STA 21, the access point AP 2 alters the transmission sequence according to the source address information (address information of STA 21) in NN so that the data addressed to other than STA 21, i.e., that addressed to STA 22 is preferentially delivered at least one position earlier in the transmission order.

On the other hand, when CTS is received from STA 11, the access point AP 2 refers to the destination address information in CTS. If it is determined that the address information indicates the access point AP 1, the access point AP 1 starts transmitting data addressed to the station STA 11 (step S6).

When the data is completely received from the access point AP 1, the station STA 11 delivers ACK thereto (step S11).

The access point AP 2 senses carriers (step S7) to initiate transmitting data to the station STA 22 according to the transmission order of data items in the queue changed in step S5 (steps S8 to S10).

After having received all data items from AP 2, the station STA 22 sends ACK to the access point AP 2 (step S12).

In this way, the communication apparatus (STA 21) in the communication system transmits the NAV setting notification indicating the setting of the transmission inhibited period (NAV) to the peripheral communication apparatuses (AP2, STA 11).

Resultantly, the peripheral apparatuses (AP2, STA 11) is capable of recognizing the communication apparatus (STA 21) to which NAV is set.

At reception of the setting notifying information NN, the communication apparatus (AP 2) controls operation so that transmission data addressed to other than the communication apparatus (STA 21) having received NN takes precedence in the transmission.

It is therefore possible that even if there exists transmission data addressed to the communication apparatus (STA 21) to which NAV is set, the communication apparatus (AP 2) preferentially transmits the data to the other communication apparatus (STA 22) to which NAV is not set.

As a result, the communication apparatus (AP 2) is capable of suppressing the retransmission of data to the communication apparatus (STA 21) to which NAV is set to thereby avoid the deterioration of the transmission efficiency.

When transmitting the NAV setting notification NN, the communication apparatus (STA 21) carries out, for example, the back-off control such that NN is fed to the peripheral communication apparatus (AP 2).

The communication apparatus (STA 21) is hence capable of notifying NN to the peripheral apparatus (AP 2) while avoiding collision of NN.

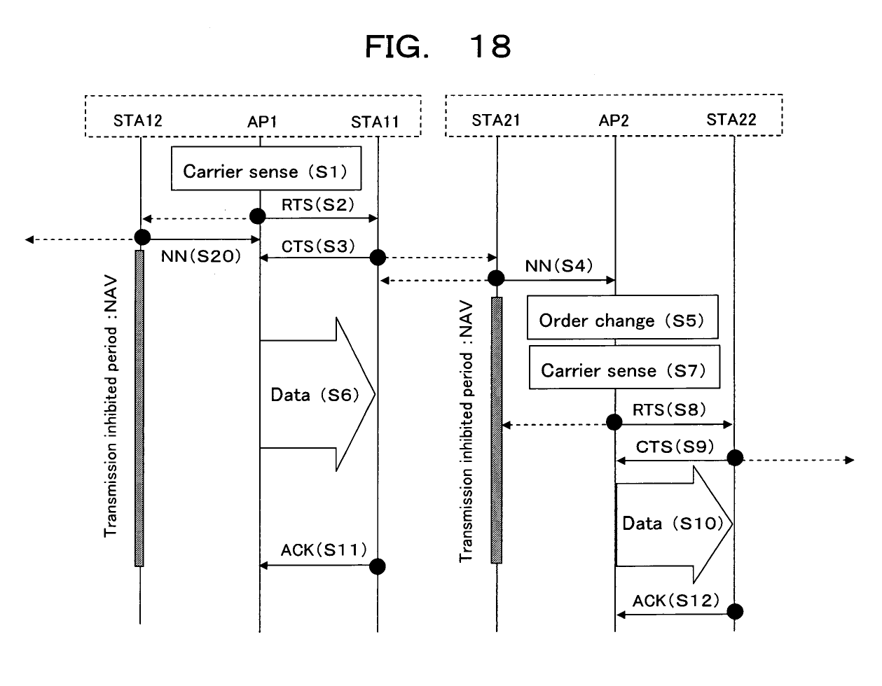

In the processing steps shown in FIG. 14, when RTS is received from AP 1 and the destination address information indicates other than STA 12, the station STA 12 refers to the channel use time information in RTS to resultantly set the transmission inhibited period (NAV). However, it is also possible as shown in FIG. 18 to configure the system in which at reception of RTS from AP 1, if the destination address information in RTS indicates other than the station STA 12, the station STA 12 sends the NN signal indicating the setting of NAV to the peripheral communication apparatus (AP 1; step S20).

This makes it possible that the peripheral apparatus (AP 1) of the station STA 12 recognizes the station STA 12 to which NAV is set.

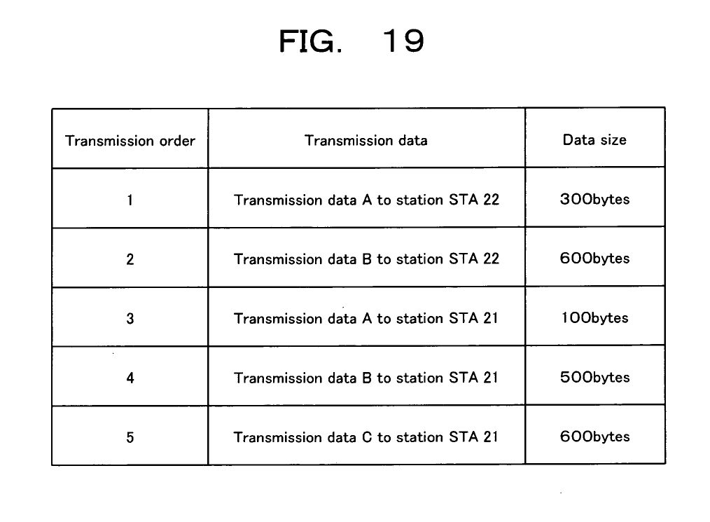

In the operation steps shown in FIG. 14, when NN is received from the station STA 21, the access point AP 2 alters the transmission order of data items in the queue of FIG. 15 to the transmission sequences shown in FIGS. 16 and 17 based on the source address information (address information of STA 21) so that the data to other than STA 21, i.e., that addressed to STA 22 is preferentially delivered at least one position earlier in the transmission order. However, the system may be configured such that at reception of NN from STA 21, the access point AP 2 changes, on the basis of the source address information (address information of STA 21), the transmission order of data items in the transmission queue of FIG. 15 to that shown in FIG. 19 so that the data items addressed to other than STA 21, namely, those addressed to STA 22 are preferentially sent at a time.

FIG. 19 shows a state in which the data items are managed in the transmission order of “data A to STA 22”, “data B to STA 22”, “data A to STA 21”, “data B to STA 21”, and “data C to STA 21”.

According to FIG. 19, the transmission order is varied so that the transmission data items addressed to other than STA 21, namely, “data A to STA 22” and “data B to STA 22” are preferentially transmitted.

As above, at reception of NN from STA 21, the access point AP 2 varies the transmission sequence on the basis of the source address information (address information of STA 21) in NN so that the data items addressed to other than STA 21, namely, those addressed to STA 22 are delivered at a time with higher priority.

In the operation in which the transmission sequence is changed to preferentially transmit the data items addressed to other than STA 21, i.e., those to STA 22 at a time, it is favorable that the access point AP 2 changes the transmission order on the basis of the length of the transmission inhibited period (NAV) of STA 21.

Assume that the data size of transmission data which the access pint AP 2 may send during the transmission inhibited period of the station STA 21 is, for example, 500 bytes.

In this situation, according to the data size of data items in the transmission queue of FIG. 15, the access point AP 2 selects, as data transmissible during the transmission inhibited period of the station STA 21, the data items addressed to other than STA 21, i.e., “data A to STA 22 including 300 bytes” and “data B to STA 22 including 600 bytes”. The access point AP 2 alters the transmission sequence to preferentially deliver the selected data items, i.e., “data A to STA 22 including 300 bytes” and “data B to STA 22 including 600 bytes”.

Resultantly, the access point AP 2 selects, from the transmission data items addressed to other than STA 21 having received NN, i.e., those to STA 22, the data items transmissible during the transmission inhibited period of the station STA 21 and delivers the selected data items with higher priority.

### Second Exemplary Embodiment

Description will next be given of the second exemplary embodiment.

When transmitting data addressed to the station STA 21 to which the transmission inhibited period, i.e., NAV is set, the access point AP 2 controls operation to preferentially send data of which the transmission completion time of delivery to STA 21 is later than the expiration time of NAV set to STA 21.

Therefore, the access point AP 2 delivers the data of which the completion time of transmission to STA 21 is later than the expiration time of NAV set to STA 21.

It is hence possible that the station STA 21 sends to the access point AP2 an acknowledge signal “ACK” to the transmission data from the access point AP2, and then the access point AP2 receives ACK.

Therefore, the access point AP2 is capable of avoiding the retransmission of data to the station STA 21.

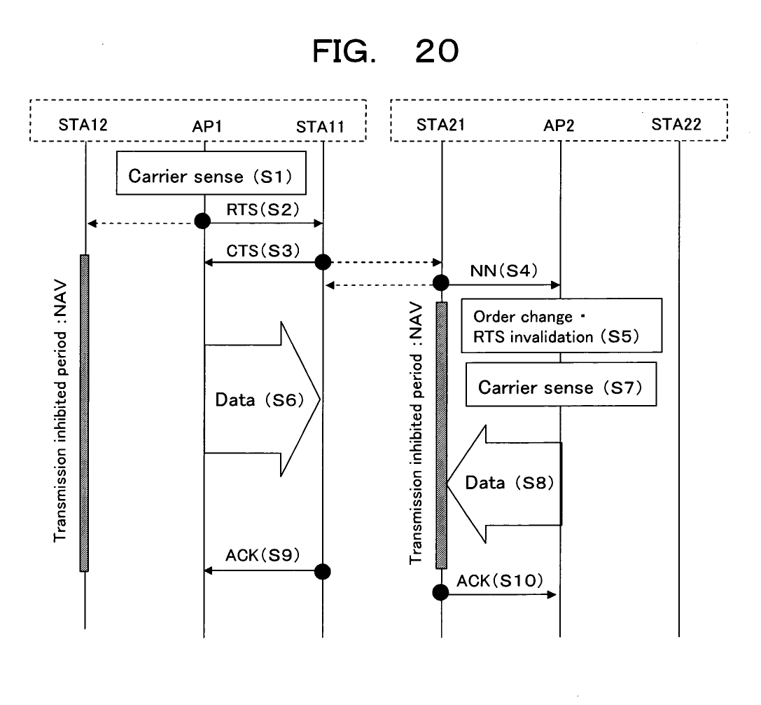

Referring to FIG. 20, description will be given of a sequence of processing executed in the communication system.

Assume in the processing of FIG. 20 that transmission data addressed to the station STA 11 occurs in the access point AP 1.

Additionally, transmission data addressed to the station STA 21 occurs in the access point AP 2.

Processing in steps S1 to S4 of FIG. 20 is executed in almost the same way as for the associated steps of the first exemplary embodiment shown in FIG. 14.

That is, the access point AP 2 receives NN delivered from the station STA 21 and the station STA 21 resultantly recognizes STA 21 to which NAV is set.

In the operation to send data addressed to STA 21 to which NAV is set, the access point AP 2 changes the transmission order based on the source address information (address information of STA 21), the NAV setting period, and the data size of the associated data in the transmission queue included in NN from STA 21 to preferentially send the transmission data of which the completion time of the delivery to STA 21 is later than the NAV expiration time.

In the transmission of data addressed to STA 21, the access point AP 2 controls operation such that the RTS/CTS change control is suppressed (step S5).

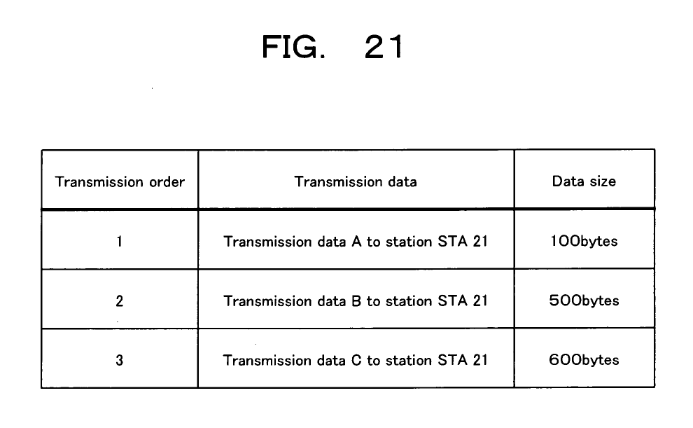

Assume that the access point AP 2 manages the data items in the transmission queue according to, for example, a transmission sequence shown in FIG. 21.

In the state of FIG. 21, the data items are managed in a transmission sequence of “data A to STA 21”, “data B to STA 21”, and “data C to STA 21”.

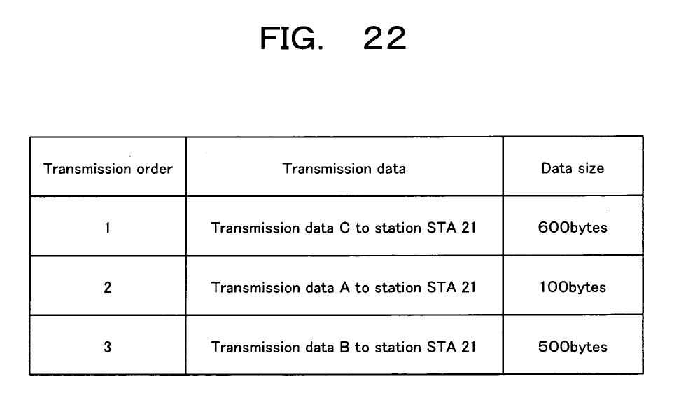

When NN is received from STA 21, the access point AP 2 alters the transmission order on the basis of the source address information (address information of STA 21), the NAV setting period, and the data size of the data in the transmission queue contained in NN so that the data of which the completion time of the delivery to STA 21 is later than the expiration time of NAV set to STA 21 is preferentially transmitted at least one position earlier in the transmission sequence as shown in FIG. 22.

FIG. 22 shows a state in which the data items are managed in a transmission order of “data C to STA 21”, “data A to STA 21”, and “data B to STA 21”.

That is, “data C to STA 21” is determined as the transmission data of which the delivery completion time is later than the NAV expiration time set to STA 21, and the transmission sequence is varied to preferentially transmit the data C addressed to the station STA 21.

As above, the access point AP 2 alters the transmission sequence to preferentially deliver the data of which the completion time of the delivery to STA 21 is later than the expiration time of NAV set to STA 21.

On the other hand, at reception of CTS from the station STA 11, the access point AP 1 checks the destination address information in CTS. If the address information indicates AP 1, the access point AP 1 initiates the transmission of data to the station STA 11 (step S6).

When the data is completely received from AP 1, the station STA 11 feeds ACK thereto (step S9).

The access point AP 2 senses carriers (step S7) to commence sending data to STA 21 to which NAV is set (step S8). In this situation, the access point AP 2 controls operation to send the transmission data without achieving the RTS/CTS change control.

It is hence possible that the access point AP 2 transmits, without carrying out the RTS/CTS change control, the data addressed to the station STA 21 to which NAV is set to thereby avoid unnecessary retransmission of data.

When the data is completely received from the access point AP 2, the station STA 21 feeds ACK thereto (step S10).

As above, in the transmission of the data addressed to STA 21 to which NAV is set, the access point AP 2 controls operation to preferentially deliver the data of which the delivery completion time to STA 21 is later than the NAV expiration time set to STA 21.

Resultantly, the access point AP 2 sends the data of which the delivery completion time is later than the NAV expiration time.

The station STA 21 transmits, to the access point AP 2, ACK to the data from AP 2 so that the access point AP 2 receives ACK to the transmission data.

The access point AP 2 is hence capable of avoiding the retransmission of the data to the station STA 21.

Also, the access point AP 2 conducts a control operation in the transmission of data to STA 21 to which NAV is set to deliver the data without conducting the RTS/CTS change control.

It is resultantly possible for the access point AP 2 to avoid the unnecessary retransmission of data.

The exemplary embodiments are only favorable embodiments in accordance with the present invention, but the present invention is not limited only to the embodiments.

For example, the configuration between the adjacent access points (AP 1, AP 2) are not particularly restricted, but any system configuration is applicable.

For example, the adjacent access points (AP 1, AP 2) may be coupled via a wired communication using a cable with each other to build the same system. In addition, the adjacent access points (AP 1, AP 2) may be not coupled via a cable with each other so that the access points configure mutually different systems.

Although it is assumed in the embodiments that the data is transmitted via a non-directional antenna, a directional antenna may be adopted if a transmission destination can be identified.

It is also possible to employ a configuration by combining the control operations of the first and second embodiments with each other.

Assume, for example, a situation in the first exemplary embodiment in which the access point AP 2 preferentially delivers the data addressed to other than STA 21 having received NN, namely, the transmission data addressed to STA 22 and the transmission queue contains only the data addressed to STA 21. The communication system may be configured such that in the situation, if it is determined that the transmission inhibited period of STA 21 is not expired, the access point AP 2 conducts operation as in the second embodiment in consideration of the period of time to be lapsed up to the expiration of the transmission inhibited period of STA 21. That is, the data of which the transmission completion time is later than the expiration time of the transmission inhibited period of STA 21 is selected from the data addressed to STA 21 and is preferentially transmitted.

Although the radio communication has been described as an example in conjunction with the embodiments, the technological idea of the embodiments are also applicable to other than the wireless communication.

The control operations in the communication apparatuses such as the access points AP and the stations STA may naturally be executed using hardware, software, or a combination thereof.

In a situation to execute processing by software, a program including a processing sequence may be installed in a memory of a computer incorporated in dedicated hardware and executed by a computer. Or, the program may be stored in a general computer capable of executing various processing and be executed by the computer.

For example, the program may be beforehand recorded on a computer-readable medium such as a hard disk or a Read Only Memory (ROM).

Alternatively, the program may be temporarily or permanently stored or recorded on a removable recording medium such as a floppy disk, a Compact Disc Read Only Memory (CD-ROM), a Magneto-Optical (MO) disk, a Digital Versatile Disc (DVD), a magnetic disk, or a semiconductor memory.

It is possible to provide such removable recording medium as package software to users.

In addition to the installation of the program from the removable recording medium in the computer, the program may also be transferred by radio from a download site to the computer or may be sent through wired communication via a network, e.g., a Local Area Network (LAN) or the internet. After receiving the program, the computer installs the program in a recording medium such as a hard disk incorporated therein.

The programs are executed not only in time series fashion according to the processing steps described for the embodiments, but may also be executed in parallel or separately depending on processing capacity of the equipment to execute the processing or according to necessity.

The communication system described may be constructed in a logical set including a plurality of apparatuses or in a configuration including the functions of respective apparatuses.

As described above, the embodiments have aspects as below.

A third exemplary embodiment is a communication system including a first communication apparatus and a second communication apparatus. The first communication apparatus may include a collision avoiding control unit that sets a transmission inhibited period and controls operation to avoid data collision during the transmission inhibited period and a notifying unit that notifies the second communication apparatus of setting notifying information indicating the setting of the transmission inhibited period. The second communication apparatus may include a transmission control unit that controls, at reception of the setting notifying information from the first communication apparatus, operation to preferentially transmit data addressed to other than the first communication apparatus.

A fourth exemplary embodiment of the invention is a communication system where the notifying unit may include a control unit that controls operation to avoid collision of the setting notifying information.

A fifth exemplary embodiment of the invention is a communication system where the control unit may control operation to avoid collision of the setting notifying information by use of back-off control.

A sixth exemplary embodiment of the invention is a communication system where the notifying unit notifies the setting notifying information to communication apparatuses existing in a communication range of the first communication apparatus, the communication apparatuses including at least the second communication apparatus.

A seventh exemplary embodiment of the invention is a communication system where the notifying unit notifies setting notifying information including apparatus identifying information to identify first communication apparatus and setting period information of the transmission inhibited period.

A eighth exemplary embodiment of the invention is a communication system where the transmission control unit controls operation to select, from the transmission data addressed to other than the first communication apparatus, second transmission data for which transmission may be started during the transmission inhibited period of the first communication apparatus to preferentially transmit the second transmission data.

A ninth exemplary embodiment of the invention is a communication system where the transmission control unit controls operation, when transmitting data addressed to the first communication apparatus, to preferentially transmit data of which a transmission completion time is later than an expiration time of the transmission inhibited period of the first communication apparatus.

A tenth exemplary embodiment of the invention is a communication system where the transmission control unit may control operation, when there exists no data addressed to other than the first communication apparatus, to transmit data addressed to the first communication apparatus.

A eleventh exemplary embodiment of the invention is a communication system where the transmission control unit transmits the data addressed to the first communication apparatus without reserving a channel.

A twelfth exemplary embodiment of the invention is a communication apparatus for setting a transmission inhibited period and controlling operation to avoid data collision during the transmission inhibited period. The communication apparatus includes a notifying unit that notifies peripheral communication apparatuses existing in a periphery of the communication apparatus of setting notifying information indicating the setting of the transmission inhibited period.

A thirteenth exemplary embodiment of the invention is a communication apparatus where the notifying unit includes a control unit that controls operation to avoid collision of the setting notifying information.

A fourteenth exemplary embodiment of the invention is a communication apparatus where the control unit controls operation to avoid collision of the setting notifying information by use of back-off control.

A fifteenth exemplary embodiment of the invention is a communication apparatus where the notifying unit notifies the setting notifying information to the peripheral communication apparatuses existing in a communication range of the communication apparatus.

A sixteenth exemplary embodiment of the invention is a communication apparatus where the notifying unit notifies setting notifying information including apparatus identifying information to identify the communication apparatus and setting period information of the transmission inhibited period.

A seventeenth exemplary embodiment of the invention is a communication apparatus for transmitting data to peripheral communication apparatuses existing in a periphery of the communication apparatus. The communication apparatus includes a transmission control unit that preferentially transmits, at reception of setting notifying information indicating setting of a transmission inhibited period to avoid data collision from one of the peripheral communication apparatuses, data addressed to other than the peripheral communication apparatus from which the setting notifying information is received.

A eighteenth exemplary embodiment of the invention is a communication apparatus where the transmission control unit controls operation to select, from the transmission data addressed to other than the peripheral communication apparatus, second transmission data for which transmission may be started during the transmission inhibited period of the peripheral communication apparatus to preferentially transmit the second transmission data.

A nineteenth exemplary embodiment of the invention is a communication apparatus where the transmission control unit controls operation, when transmitting data addressed to the peripheral communication apparatus, to preferentially transmit data of which a transmission completion time is later than an expiration time of the transmission inhibited period of the peripheral communication apparatus.

A twentieth exemplary embodiment of the invention is a communication apparatus where the transmission control unit controls operation, when there exists no data addressed to other than the peripheral communication apparatus, to transmit data addressed to the peripheral communication apparatus.

A twenty-first exemplary embodiment of the invention is a communication apparatus where the transmission control unit transmits the data addressed to the peripheral communication apparatus without reserving a channel.

A twenty-second exemplary embodiment of the invention is a communication control method for use with a communication system including a first communication apparatus and a second communication apparatus. The first communication apparatus conducts a collision avoiding control process for setting a transmission inhibited period and controlling operation to avoid data collision during the transmission inhibited period and a notifying process for notifying the second communication apparatus of setting notifying information indicating the setting of the transmission inhibited period. The second communication apparatus conducts a transmission control process for controlling, at reception of the setting notifying information from the first communication apparatus, operation to preferentially transmit data addressed to other than the first communication apparatus.

A twenty-third exemplary embodiment of the invention is a communication control method for use with a communication apparatus for setting a transmission inhibited period and controlling operation to avoid data collision during the transmission inhibited period. The communication apparatus conducts a notifying process for notifying peripheral communication apparatuses existing in a periphery of the communication apparatus of setting notifying information indicating the setting of the transmission inhibited period.

A twenty-fourth exemplary embodiment of the invention is a communication control method for use with a communication apparatus for transmitting data to peripheral communication apparatuses existing in a periphery of the communication apparatus. The communication apparatus conducts a transmission control process to preferentially transmit, at reception of setting notifying information indicating setting of a transmission inhibited period to avoid data collision from one of the peripheral communication apparatuses, data addressed to other than the peripheral communication apparatus from which the setting notifying information is received.

A twenty-fifth exemplary embodiment of the invention is a communication control program stored on a computer-readable medium for setting a transmission inhibited period and controlling operation to avoid data collision during the transmission inhibited period. The program causes a computer to perform notifying processing for notifying peripheral communication apparatuses existing in a periphery of the communication apparatus of setting notifying information indicating the setting of the transmission inhibited period.

A twenty-sixth exemplary embodiment of the invention is a communication control program for transmitting data to peripheral communication apparatuses existing in a periphery of the communication apparatus. The program causes a computer to perform transmission control processing to preferentially transmit, at reception of setting notifying information indicating setting of a transmission inhibited period to avoid data collision from one of the peripheral communication apparatuses, data addressed to other than the peripheral communication apparatus from which the setting notifying information is received.

The communication systems, the communication apparatuses, the communication control methods, and the communication control programs described in conjunction with the embodiments are applicable to communication systems for audio communication requiring high-grade radio communication.

Also, the communication systems, the communication apparatuses, the communication control methods, and the communication control programs of the embodiments may be applied to systems including a high-speed handover function requiring direct negotiation between access points.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system, comprising:
a first communication apparatus; and
a second communication apparatus,
the first communication apparatus comprising,
a collision avoiding control unit that sets a transmission inhibited period and controlling operation to avoid data collision during the transmission inhibited period and
a notifying unit that notifies the second communication apparatus of setting notifying information indicating the setting of the transmission inhibited period,
the second communication apparatus comprising a transmission control unit that controls, at reception of the setting notifying information from the first communication apparatus, operation to preferentially transmit data addressed to other than the first communication apparatus.

2. The communication system in accordance with claim 1, wherein the notifying unit comprises a control unit that controls operation to avoid collision of the setting notifying information.

3. The communication system in accordance with claim 2, wherein the control unit controls operation to avoid collision of the setting notifying information by use of back-off control.

4. The communication system in accordance with claim 1, wherein the notifying unit notifies the setting notifying information to communication apparatuses existing in a communication range of the first communication apparatus, the communication apparatuses including at least the second communication apparatus.

5. The communication system in accordance with claim 1, wherein the notifying section notifies setting notifying information including apparatus identifying information to identify the first communication apparatus and setting period information of the transmission inhibited period.

6. The communication system in accordance with claim 1, wherein the transmission control unit controls operation to select, from the transmission data addressed to other than the first communication apparatus, second transmission data for which transmission may be started during the transmission inhibited period of the first communication apparatus to preferentially transmit the second transmission data.

7. The communication system in accordance with claim 1, wherein the transmission control unit controls operation, when transmitting data addressed to the first communication apparatus, to preferentially transmit data of which a transmission completion time is later than an expiration time of the transmission inhibited period of the first communication apparatus.

8. The communication system in accordance with claim 7, wherein the transmission control unit controls operation, when there exists no data addressed to other than the first communication apparatus, to transmit data addressed to the first communication apparatus.

9. The communication system in accordance with claim 7, wherein the transmission control unit transmits the data addressed to the first communication apparatus without reserving a channel.

10. A communication system, comprising:
a first communication apparatus; and
a second communication apparatus,
the first communication apparatus comprising,
collision avoiding control means for setting a transmission inhibited period and controlling operation to avoid data collision during the transmission inhibited period and
notifying means for notifying the second communication apparatus of setting notifying information indicating the setting of the transmission inhibited period,
the second communication apparatus comprising transmission control means for controlling, at reception of the setting notifying information from the first communication apparatus, operation to preferentially transmit data addressed to other than the first communication apparatus.

11. A communication apparatus for setting a transmission inhibited period and controlling operation to avoid data collision during the transmission inhibited period, comprising
a notifying unit that notifies peripheral communication apparatuses existing in a periphery of the communication apparatus of setting notifying information indicating the setting of the transmission inhibited period.

12. The communication system in accordance with claim 11, wherein the notifying unit comprises a control unit that controls operation to avoid collision of the setting notifying information.

13. The communication system in accordance with claim 12, wherein the control unit controls operation to avoid collision of the setting notifying information by use of back-off control.

14. The communication system in accordance with claim 11, wherein the notifying unit notifies the setting notifying information to the peripheral communication apparatuses existing in a communication range of the communication apparatus.

15. The communication system in accordance with claim 11, wherein the notifying unit notifies setting notifying information including apparatus identifying information to identify the communication apparatus and setting period information of the transmission inhibited period.

16. A communication apparatus for setting a transmission inhibited period and controlling operation to avoid data collision during the transmission inhibited period, comprising
notifying means for notifying peripheral communication apparatuses existing in a periphery of the communication apparatus of setting notifying information indicating the setting of the transmission inhibited period.

17. A communication apparatus for transmitting data to peripheral communication apparatuses existing in a periphery of the communication apparatus, comprising
a transmission control unit that preferentially transmits, at reception of setting notifying information indicating setting of a transmission inhibited period to avoid data collision from one of the peripheral communication apparatuses, data addressed to other than the peripheral communication apparatus from which the setting notifying information is received.

18. The communication system in accordance with claim 17, wherein the transmission control unit controls operation to select, from the transmission data addressed to other than the peripheral communication apparatus, second transmission data for which transmission may be started during the transmission inhibited period of the peripheral communication apparatus to preferentially transmit the second transmission data.

19. The communication system in accordance with claim 17, wherein the transmission control unit controls operation, when transmitting data addressed to the peripheral communication apparatus, to preferentially transmit data of which a transmission completion time is later than an expiration time of the transmission inhibited period of the peripheral communication apparatus.

20. The communication system in accordance with claim 19, wherein the transmission control unit controls operation, when there exists no data addressed to other than the peripheral communication apparatus, to transmit data addressed to the peripheral communication apparatus.

21. The communication system in accordance with claim 19, wherein the transmission control unit transmits the data addressed to the peripheral communication apparatus without reserving a channel.

22. A communication apparatus for transmitting data to peripheral communication apparatuses existing in a periphery of the communication apparatus, comprising
transmission control means for preferentially transmitting, at reception of setting notifying information indicating setting of a transmission inhibited period to avoid data collision from one of the peripheral communication apparatuses, data addressed to other than the peripheral communication apparatus from which the setting notifying information is received.

23. A communication control method for use with a communication system comprising a first communication apparatus and a second communication apparatus,
the first communication apparatus conducting,
a collision avoiding control process for setting a transmission inhibited period and controlling operation to avoid data collision during the transmission inhibited period and
a notifying process for notifying the second communication apparatus of setting notifying information indicating the setting of the transmission inhibited period,
the second communication apparatus conducting a transmission control process for controlling, at reception of the setting notifying information from the first communication apparatus, operation to preferentially transmit data addressed to other than the first communication apparatus.

24. A communication control method for use with a communication apparatus for setting a transmission inhibited period and controlling operation to avoid data collision during the transmission inhibited period,
the communication apparatus conducting a notifying process for notifying peripheral communication apparatuses existing in a periphery of the communication apparatus of setting notifying information indicating the setting of the transmission inhibited period.

25. A communication control method for use with a communication apparatus for transmitting data to peripheral communication apparatuses existing in a periphery of the communication apparatus,
the communication apparatus conducting a transmission control process for preferentially transmitting, at reception of setting notifying information indicating setting of a transmission inhibited period to avoid data collision from one of the peripheral communication apparatuses, data addressed to other than the peripheral communication apparatus from which the setting notifying information is received.

26. A communication control program stored on a computer-readable medium for setting a transmission inhibited period and controlling operation to avoid data collision during the transmission inhibited period,
the program causing a computer to perform notifying processing for notifying peripheral communication apparatuses existing in a periphery of the communication apparatus of setting, notifying information indicating the setting of the transmission inhibited period.

27. A communication control program stored on a computer-readable medium for transmitting data to peripheral communication apparatuses existing in a periphery of the communication apparatus,
the program causing a computer to perform transmission control processing for preferentially transmitting, at reception of setting notifying information indicating setting of a transmission inhibited period to avoid data collision from one of the peripheral communication apparatuses, data addressed to other than the peripheral communication apparatus from which the setting notifying information is received.
